(19) United States
(12) Patent Application Publication
(10) Pub. No.: US 2006/0224723 A1
(43) Pub. Date: Oct. 5, 2006

(54) Data updating system and method

(75) Inventor: Chih-Wei Chen, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/096,326

(22) Filed: Mar. 30, 2005

(51) Int. Cl. G06F 15/173

(52) U.S. Cl. 709/224

(57) ABSTRACT

An data updating system and method are proposed. The data updating system and method are applicable to a at least a first server and a second server linked to establish a networking connection via a network system, and operation condition of each of the servers is determined to be normal or abnormal according to heart beats transmitted between the servers. In the data updating system, a storage is established in the network system. Then, if a request for data updating is received by the first server, updated data responsive to the request for data updating is stored in the storage. Subsequently, the first server is inhibited from transmitting the heart beat to the second server, and the second server linked to the network system takes over service operation originally provided by the first server, allowing the updated data stored in the storage to be installed in the first server. Finally, a rebooting procedure is performed to reboot the first server after the updated data has been installed in the first server, so that the first server can provide service operation according to the updated data.

### FIELD OF THE INVENTION

The present invention relates to data updating systems and methods, and more particularly, to a data updating system and method applicable to at least two servers having network connection.

### BACKGROUND OF THE INVENTION

With Regard to a network system, (such as Internet, Intranet and Local Area Network (LAN), a server which serves to the client end computers often comprises at least a backup server in order to prevent service quality of accessing data from from the client end computers from being affected as a result of an operation problem of the server. A heart beat (or a regular operation signal known by persons skilled in the server technology) detecting mechanism is employed between these servers, so that if a problem occurs in one of the servers, the service operation performed by the server that has problems, is executed by other servers.

FIG. 1(A) shows a schematic diagram of the operation of a double server backup system. As shown in the diagram, a first server 1 is used to perform first service operation 10 and second service operation 11 whereas a second server 2 is used to perform third service operation 20 and fourth service operation 21. The first server 1 and the second server 2 are linked via a network system 3 (such as Internet, Intranet or Local Area Network (LAN)), such that the first server 1 and the second server 2 can determine whether the server is operating normally by detecting heart beats 12 and 22 transmitted from each other. In other words, if the heart beat has not been sent out, it means that a problem has already occurred in the server which does not send out the heat beat. FIG. 1(B) is a schematic diagram showing operation of the double server backup system having a problem occurred in one of the two servers. When a second server 2′ cannot operate as usual to transmit the heat beat 22 to a first server 1′, the third service operation 20 and the fourth service operation 21 originally executed by the second server 2′ can be installed and executed by the first server 1′ via the network system 3. Therefore, data access service provided for the client is not affected or stopped according to the foregoing supportive method.

The foregoing supportive method, however, is unable to solve a problem of the data access service interruption during the data updating operation of the server. During the data updating operation of the server, an updating program needs to be acquired from a memory equipment such as a compact disc or acquired online, such that the data updating operation of the server can only be accomplished after the service operating of the server has been terminated a reboot after installing and executing the updating program. Therefore, the data updating operation of the server results in the interruption of the data access service provided by the server for the client end computers.

Furthermore, if the service is not stopped during the updating operation for the server, to enable the server to execute updated software/firmware while serving to the client end computers, the server during the updating operation would not be ensured to provide the correct service.

Therefore, it is desirable to provide a data updating mechanism capable of providing continual data access service for the client end computers without interruption during the updating operation of the server.

### SUMMARY OF THE INVENTION

In light of the above prior-art drawbacks, an objective of the present invention is to provide a data updating system and method which can ensure continual data access service without interruption for a client end computer during data updating operation of a server, so as to improve service quality of a network system.

In accordance with the above and other objectives, the present invention proposes a data updating system and method. The data updating system proposed in the present invention is applicable to at least a first server and a second server linked to establish a networking connection via a network system. Also, operation condition of each of the servers is determined to be normal or abnormal according to heart beats transmitted between the servers, such that service operation of the network system is not affected when performing data updating operation for the server. The data updating system comprises at least a strange; at least a receiving module provided in the first server for receiving a request for data updating and updated data for the server; a processing module for storing in the strange the updated data received by receiving module when the request for data updating is received by the receiving module, wherein the first server is refrained from transmitting the heart beat to the record server, and the second server which is linked to the network system takes over service operations originally provided by the first server, such that the updated data stored in the storage can be installed in the first server; and a reboot processing module for performing a rebooting procedure when the updated data stored in the storage has been installed in the first server, so that the first server can resume the service operation according to the updated data.

The data updating method proposed in the present invention is applicable to a plurality of servers, including at least at first server and a second server, linked to establish a networking connection via a network system. Also, operation condition of each of the servers is determined to be normal or abnormal according to heart beats transmitted between the servers, In accordance with the data updating method, the first server in the network system serves to determine whether a request for data updating is received or not. If the request for data updating is received, updated data corresponding to the request is stored in the storage. Subsequently, the first server is inhibited from transmitting the heart beat to the second server, and the second server which is linked to the network system take over service operation which is originally provided by the first server. Further, the updated data stored in the storage is installed into the first server. Finally, a rebooting procedure is performed immediately after the first server has completed the installation of the updated data, so that the first server can provide the service operation according to the updated data.

The data updating system and method proposed in the present invention are capable refraining the server to be updated from transmitting the heart beat during the updating operation of the server, so that other backup servers linked to the network system take over service operation which is originally provided by the server to be updated. Moreover, the service operation taken over by the backup server is handed back to the server to be updated after the updating operation has been completed, and the updated server can provide service work according to the updated data, so as to achieve continual service provided by the server without interruption during the updating operation.

It should be noted that the first server aforementioned and recited hereinafter is meant to refer to a server that is subject to data updating, and the second server aforementioned and recited hereinafter is meant to refer to a server that serves as a backup one for the first server when proceeding to data updating. Furthermore, the network system to which the data updating system and method are applicable may include more than two servers connected to each other, other than the aforementioned first and second servers.

### BRIEF DESCRIPTION OF THE DRAWINGS

The present invention can be more fully understood by reading the following detailed description of the preferred embodiments, with reference made to the accompanying drawings, wherein:

FIG. 1(A) and 1(B) (PRIOR ART) are schematic diagrams showing operation of a double server backup system according to the prior-art;

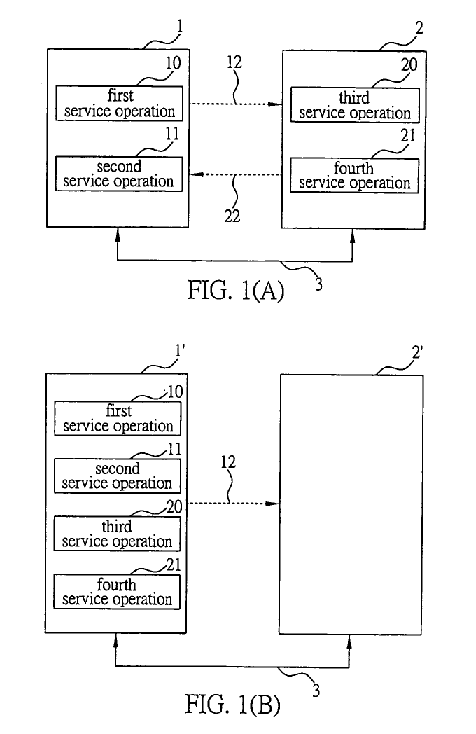

FIG. 2 is a block diagram showing a basic construction of the data updating system according to the first embodiment of the present invention;

FIG. 3 is a block diagram showing a basic construction of the data updating system according to the second embodiment of the present invention; and

FIG. 4 is a flowchart showing operation of the data updating method according to the present invention.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

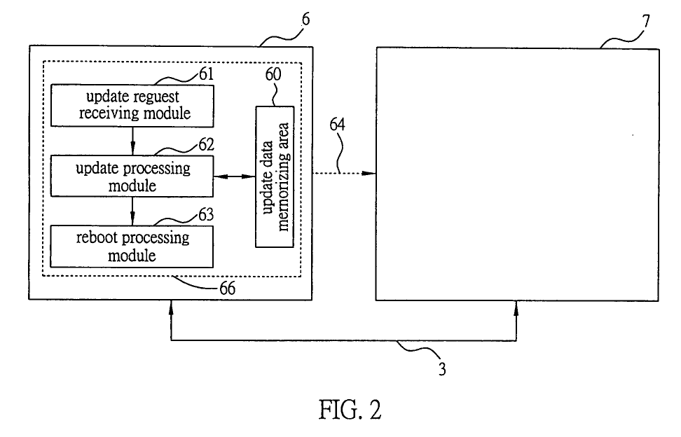

FIG. 2 is a block diagram showing a basic construction of a data updating system 66 applicable to a first server 6 which is linked to a second server 7 via a network system 3, according to the first embodiment of the present invention. As shown in the diagram, the first server 6 and the second server 7 is interlinked via a network system 3 (such as Internet, Intranet and Local Area Network) to establish a networking connection. In the present embodiment, the first server 6 is a main server and the second server 7 serves as a backup server for the first server 6. It should be noted that the quantity of the servers linked by the network system 3 is not limited by the present embodiment, and more than two servers can be used. Furthermore, the data updating system 66 is not only applicable to the main server 6, but also applicable to the backup server 7 depending on implementing situation.

When a problem occurs in the first server 6, the second server 7 is able to immediately take over service work which is originally provided by the first server 6. The second server 7 is capable of detecting an operation status of the first server 6 based on whether a regular operation signal 64 (also known by those skilled in the server technology) transmitted from the first server 6 has been received. In other words, if the heart beat 64 transmitted from the first server 6 can be received by the second server 7, the first server 6 determined to be is currently at its normal operation state. On the contrary, if the heart beat 64 transmitted from the first server 6 is not received by the second server 7, it is determined that a problem may have occurred in the operation of the first server 6. Thus, the second server 7 will then take over the service work which is originally provided by the first server 6 via the network system 3. It is a basic operating method in a prior-art double backup server system to use transmission of the heart beat as a reference for determining whether the operation status of the main server is normal, and thus details thereof will not be further described herein. Further, only system components relevant to the present invention are described in the following for simplifying the description and drawings.

In the present embodiment, the first server 6 which employs the data updating system 66 comprises an storage 60 for storing up updated data, a receiving module 61, a processing module 62 and a reboot processing module 63. The storage 60 may be a memory area provided by a hard disk of the first server 6 (not shown) for storing updated data, such as a basic input/output system program (BIOS program), an operating system, an application program or configuration setting data executed in the updating operation of the first server 6.

The receiving module 61 is used to receive a request for data updating submitted by the first server 6 or updated data required by the first server 6 for performing the updating operation. The receiving module 61 may be connected to a keyboard or a touch board. Alternatively, the receiving module 61 may directly establish a networking connection with the network system 3 for inputting the update request for data updating or the updated data.

The update processing module 62 is used for storing in the storage 60 the updated data received by receiving module 61, when the receiving module 61 is made to receive the request for data updating. Then, the first server 6 is controlled by the processing module 62 to be refrained from transmitting the heart beat 64 to the second server 7, and the second server 7 which is linked to the network system 3 is controlled by the processing module 62 to take over the service operation (not shown) which is originally performed by the first server 6. Further, the first server 6 is installed with the updated data stored in the storage 60.

The reboot processing module 63 is used for rebooting the first server 6 after the first server 6 has completed the installation of the updated data stored in the storage 60. The first server 6 then is able to resume the service work according to the updated data and transmit the heart beat 64 to the second server 7 via the network system 3, such that the second server 7 can be relieved from the service work previously taken over from the first server 6.

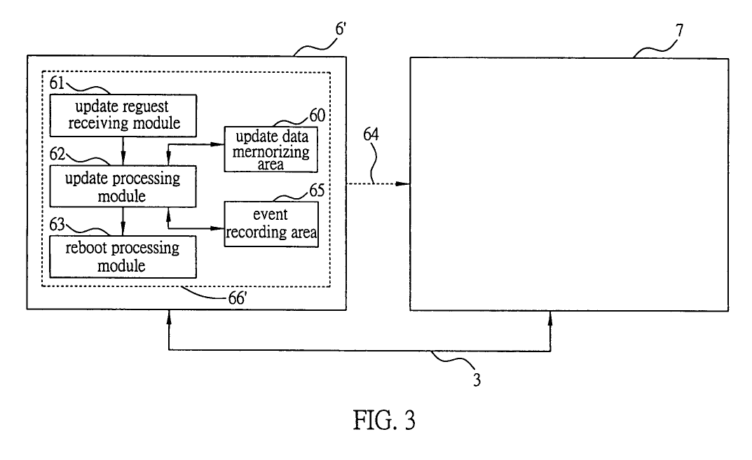

FIG. 3 is a block diagram showing a basic construction of a data updating system 66′ applicable to a server 6′ according to the second embodiment of the present invention. As shown in the diagram, certain components of the data updating system 66′ of the present embodiment are consistent with those described in the first embodiment, and thus only the different components are illustrated. Apart from the components of the first embodiment, the data updating system 66′ of the present embodiment also comprises an event recording module 65. The event recording module 65 is provided by a hard disk (not shown) of the first server 6′, for recording whether the first server 6′ has already been appointed as a backup server for performing service operation of another server linked therewith. For example, if the first server 6′ in the present embodiment has already been appointed as the backup server, the first server 6′ has taken over service operations for other servers. Accordingly, when and the processing module 62 has detected that a request for data updating is received by the receiving module 61, the processing module 65 will check with the event recording module 65. If the first server 6′ is detected as the appointed server (the backup server) for performing the service operations for other servers according to the record in the event recording module 65, the processing module 62 will performs the updating operation for the first server 6′ after a predetermined period of time (for example, one hour). In other words, the processing module 62 will not perform the updating operation until the first server 6′ is detected that it has been relieved from serving as the backup server.

As the updating operation of the first server 6′ (backup server) is delayed in response to the record in the event recording module 65, the operation and service quality of the network system can be prevented from being affected by the updating operation of the server.

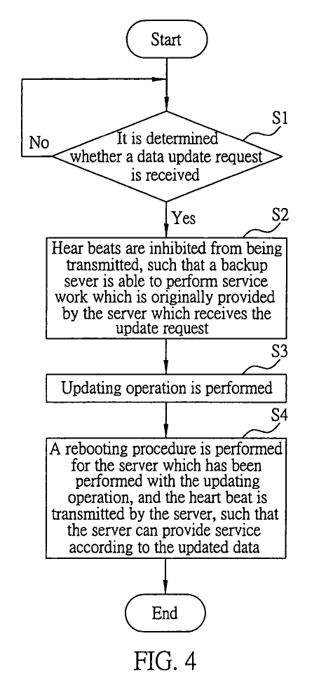

FIG. 4 is a flowchart showing operation of a data updating method according to the present invention. As shown in the diagram, in Step S1, the receiving module 61 of the first server 6 determines whether the for data updating request is received or not. If the request for data updating is received, then proceeds to Step S2.

In Step S2, the processing module 62 controls the first server 6 not to transmit the heart beat to the second server 7 according to the request for data updating received by the receiving module 61, and enables the second server 7 which is linked to the network system to perform (i.e. take over) service work for the first server 6.

In Step S3, the processing module 62 retrieves the updated data from the storage 60 and installs the updated data into the first server 6, so as for the first server 6 to have the updated data.

In Step S4, the reboot processing module 63 reboots (turns on) the first server 6 which has completed the data updating, allowing the first server 6 to transmit the heart beat after the reboot. And in the meantime, the second server 7 is relieved from the service work taken over from the first server 6, and the first server 6 can provide the service work according to the updated data.

Furthermore, in another embodiment of the data updating method proposed in the present invention, the processing module 62 will first check with records in the event recording module (not shown in FIG. 4 but in FIG. 3) before Step S2 is performed. If the record in the event recording module indicates that the first server 6 has taken over service work from other servers, Step S2 through to Step S4 shown in FIG. 4 are halted until the first server 6 is relieved from the service work taken over from the other servers.

Therefore, during the data updating operation of the server, the data updating system and method proposed in the present invention ensures continual service provided by the network system, so as to effectively solve the problem of service interruption during the conventional updating operation of the server.

The foregoing embodiments only serve to provide description for the present invention with no intent to limit the scope of the invention. Apart from the hard disk built in each of the servers, the storage 60 and the event recording module 65 described in the foregoing embodiments can also be constructed in a storage medium such as a flash disk, a floppy disk or a memory card which is electrically connected to each of the servers. Alternatively, the storage 60 and the event recording module 65 may be built in an electronic equipment (such as a personal computer or a notebook computer) that establishes a networking connection with the network system 3. Moreover, the data updating system proposed in the present invention is directly built in each of the servers. The data updating can also be incorporated into a peripheral device for being externally to each of the servers. Further, the data updating system proposed in the present invention may be partly built in the server, and partly built in the electronic equipment which is electrically connected to the server. In other words, the construction of the data updating system is not specifically limited to be built into only a single device.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A data updating system applicable to a at least a first server and a second server linked by a network system for establishing a network connection, wherein each of the servers is determined to be in a normal or an abnormal operation condition according to heart beats transmitted between the servers, the data updating system comprising at least:
a storage for storing updated data;
at least a receiving module provided in the first server for receiving an request for data updating and updated data;
a processing module for storing in the storage the updated data received by the receiving module at the time the receiving module receives the request for data updating, and for refraining the first server from transmitting the heart beat to the second server, so that service operations provided by the first server are taken over by the second server linked via the network system, in order to the updated data stored in the storage to be installed in the server; and
a reboot processing module for rebooting the first server so as to resume the service operations based on the updated data received, upon detecting completion of the installation of the updated data in the first server.

2. The data updating system of claim 1, wherein after the reboot processing module has rebooted the first server, the first server is designed to transmit the heart beats to the second server linked via the network system, so as to terminate the service operations provided by the second server.

3. The updating device of claim 2, further comprising an event recording module for recording whether the first server that receives the request for data updating has already been appointed as a backup server for taking over the service operation from another server linked via the network system, allowing the processing module to check with the event recording module to determined whether to initiate data updating process after the receiving module receives the request for data updating, so that the processing module proceeds to perform the data updating process, if the first server does not serve as a backup one and holds back the performance of the data updating process for a predetermined a period of time, if the first server serves as a backup one.

4. The updating device of claim 1, wherein the updating device is constructed in each of the servers.

5. The data updating system of claim 1, wherein the network system is one selected from a group consisting of Internet, Intranet and Local Area Network (LAN).

6. An data updating method applicable to at least a first server and a second server linked via a network system to establish a network connection, wherein each of the servers is determined to be in a normal or an abnormal operation condition according to heart beats transmitted between the servers, the data updating method at least comprising steps of:
Storing updated data in a storage once a request for data updating is received;
Refraining the first server from transmitting the heart beat to the second server, such that the second server linked via the network system is made to take over service operations provided by the first server, followed by installing the updated data stored in the storage in the first server; and
rebooting the first server after the updated data has been installed in the first server, so that the first server can resume the service operations according to the updated data.

7. The data updating method of claim 6, wherein wherein after the reboot processing module has rebooted the first server, the first server is designed to transmit the heart beats to the second server linked via the network system, so as to terminate the service operations provided by the second server.

8. The data updating method of claim 6, further comprising a step of checking whether the first server has already been appointed as a backup server for another server after the request for data updating is received, so that the first server does not initiate data updating process for at least a predetermined period of time if the first server has already served as a backup one and, the first server proceeds to perform the data updating process if the first server does not serve as a backup one.

9. The data updating method of claim 8, wherein the storage is built in each of the servers.

10. The data updating method of claim 6, wherein the updated data memorizing area is built in each of the servers.

11. The updating method of claim 6, wherein the network system is selected from a group consisting of Internet, Intranet and LAN.
